(19) United States
(12) Patent Application Publication
(10) Pub. No.: US 2007/0104334 A1
(43) Pub. Date: May 10, 2007

(54) Acoustic landscape

(76) Inventors: Richard Franklin Dallam II, Seattle, WA (US); William Patrick Fontana, San Francisco, CA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/441,801

(22) Filed: May 26, 2006

Related U.S. Application Data
(60) Provisional application No. 60/684,880, filed on May 26, 2005.

(51) Int. Cl. H04B 3/00; H04B 5/00

(52) U.S. Cl. 381/77; 381/79; 381/82

(57) ABSTRACT

A system (7) for providing sound includes a sound library (4) having at least one sound, a substantially unidirectional speaker (1), an amplifier (2), and a control system (3). The amplifier (2) transmits a selected sound from the sound library (4) to the speaker (1). The speaker (1) is selectively positioned to direct the selected sound to a target location so that a first person (5) at the target location hears the selected sound, while a second person (6) proximate to the target location generally does not hear the selected sound. The sound is selected to evoke a positive response from a person (5) at the target location.

### CROSS-REFERENCE TO RELATED APPLICATION

This application claims the benefit of U.S. Provisional Patent Application Ser. No. 60/684,880, filed May 26, 2005; the disclosures of which are all hereby expressly incorporated by reference.

### TECHNICAL FIELD

The presently claimed subject matter relates generally to a systems for providing sound and more specifically to systems for providing sound to evoke a positive response from a person.

### BACKGROUND

When it comes to healing, hospitals are a fertile source of negative stressors. Environmental elements can increase stress if their presence is uncontrollable and difficult to ignore. Negative distractions may be embedded in the physical environment or in processes not under the patient's control. Noise in the hospital setting, for example, is a severe environmental stressor. It has been found to produce harmful psychological effects, including elevated blood pressure, increased heart rate, and sleeplessness. The disruption in sleep has a direct impact on a patient's ability to heal, resulting in a greater need for sedation and longer hospitalization.

Noise is a pervasive problem in hospitals for several reasons. First, noise sources are numerous (pagers, alarms, hallway conversations) and loud (use or movement of medical equipment and shift changes). Second, patients in multiple-occupancy rooms are subjected to the additional noises of roommates and their visitors and caregivers. Patient satisfaction data consistently show that patients without roommates are far more satisfied with the noise level in and around their rooms than patients with roommates. Third, environmental surfaces in hospitals (floors and ceilings) are usually sound reflecting rather than sound absorbing, contributing to poor acoustic conditions. Even in single rooms, a recent study indicated noise as the number one dis-satisfier with patients.

Nurses in the surgical thoracic intermediate care area of one hospital used a noise dosimeter to obtain continuous recordings of decibel levels in the unit during two night shifts. The dosimeter was placed inside empty patient rooms without the night staff's knowledge. Shift change commotion and equipment such as portable x-ray machines, hallway phones, and bedside monitor alarms caused the highest decibel peaks. The 98 decibels recorded for a portable x-ray machine, for example, is as loud as a motorcycle. A number of staff and equipment changes were instituted following the research. These changes included routinely closing the doors to patients' rooms, stopping middle-of-the-night supply deliveries to the nursing unit, softening the noise of charts being returned to holders outside patient rooms by padding the holders, modifying bedside cardiac monitors so that alarms could be set at a lower level, and performing routine chest x-rays earlier in the evening.

Noise in hospitals affects staff as well as patients. In one coronary intensive care unit, researchers periodically rotated sound-reflecting and sound-absorbing ceiling tiles to test the effects on staff and patients. Good acoustics had positive effects not only on patients (e.g., lower incidence of rehospitalization), but also on the staff. These include improved quality of patient care, better sleep quality at home, and better speech intelligibility.

Now, the next field of study for sound in hospitals is taking shape. It goes beyond sound masking to intentionally introduce sounds into hospital environments to optimize a patient's psychophysiological state before procedures and enable recovery after surgery.

Patients scheduled to undergo surgical procedures often say that they sense a loss of control and autonomy. This may induce anxiety and a feeling of helplessness, which also could be related to being in an unfamiliar environment. Postoperative pain and nausea may prolong recovery, and the experience of psychological tension may affect the cardiovascular and immune systems.

Pharmacological methods to improve postoperative pain and nausea are well documented, but an increasing interest in non-pharmacological methods—particularly pleasant auditory stimulation—has prompted research in this field. The use of music during and after surgery has attracted attention recently, and several studies and reviews on the topic have been published. Although many of these have not fulfilled standard criteria for randomization and control of circumstances, some recent studies point to a direct pain-reducing effect from patients' perioperative exposure to music.

Traditional pharmacological therapeutic interventions for the relief of perioperative anxiety and pain are being challenged by an increasing demand for complementary and more holistic approaches.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A very unidirectional speaker is aimed at a target location to direct pleasant, soothing sounds to a person at the target location. Such sounds can be indigenous to the region where the person is located. By the sound being unidirectional, such sound is not heard by people outside of the sound path. Ultrasonic or other technology can be utilized to achieve the unidirectionality of the sound. The purpose of the sound is not to mask all other sounds, but to impart a pleasing sound to the person while still being able to hear other sounds, perhaps the voice of a caregiver or other person.

A control system, whether a remote control unit or a control panel allows the listener to select different sounds. Providing a selection of sounds recognizes that a pleasant sound to one person may not be as pleasant to another. Also, sounds may be pleasant for a fixed period of time, but no longer pleasant if continued for a longer duration. The control unit may also, to some extent, allow the volume of the sound to be controlled. Also, other control features may be utilized, for example, a timer for automatically turning off the sound source after a period of time.

A library of sounds is provided, as well as an amplifier to transmit the sound signal to the unidirectional speaker. In a multiple station arrangement, a central sound library may be utilized with a central control system to transmit the selected sounds to the applicable speaker. The sounds may be stored on various storage media, for example, floppy disks, optical disks, magnetic tape, hard drives, flash memory devices, etc.

The unidirectional sound system may be utilized in the health care area, for example, at a station used to draw blood, a station used to measure blood pressure, or a surgical prep area. The presently claimed subject matter may also be used during chemotherapy, kidney dialysis, or other procedures in which the patient is immobilized for a period of time. The presently claimed subject matter may in addition be utilized with patients while in bed.

The presently claimed subject matter is not limited for use in the health care arena, but can be used in all manner of situations and locations, including in the workplace, while traveling in airplanes, trains, boats, etc., in waiting areas, etc.

### DESCRIPTION OF THE DRAWINGS

The foregoing aspects and many of the attendant advantages of presently claimed subject matter will become more readily appreciated as the same become better understood by reference to the following detailed description, when taken in conjunction with the accompanying drawings, wherein:

FIG. 1 is a view of one embodiment of the presently disclosed system for providing sound with a health care patient at the target location of the system.

FIG. 2 is a block diagram of one embodiment of the presently disclosed system for providing sound.

### DETAILED DESCRIPTION

The presently claimed subject matter is described herein with reference to the accompanying illustrations where like numerals correspond to like elements.

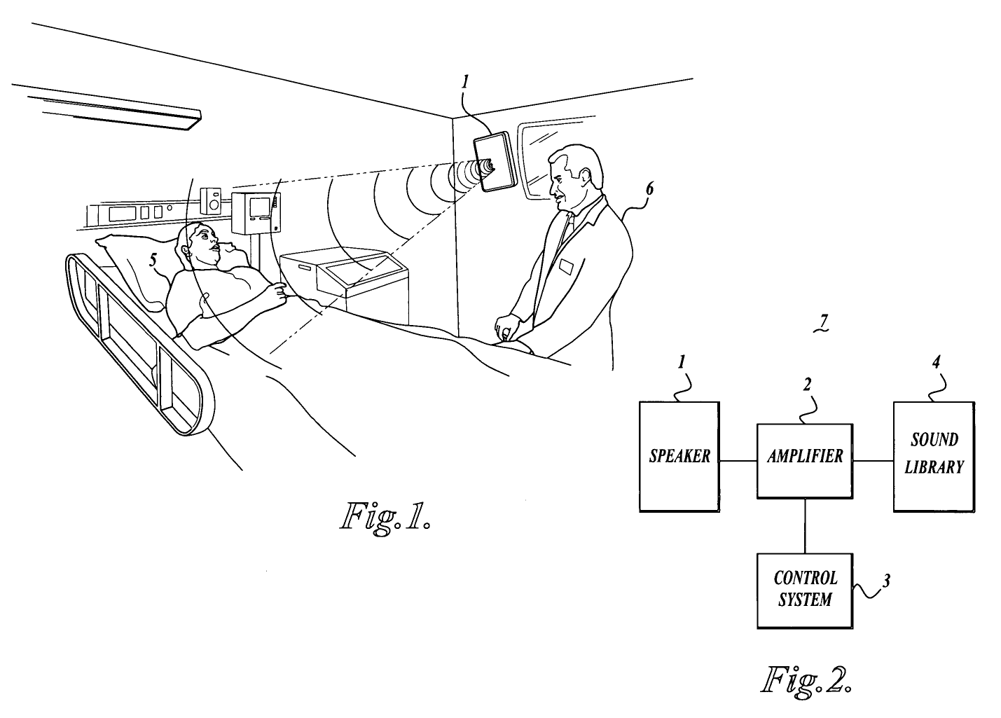

One suitable embodiment of a system 7 for providing sound is illustrated in FIGS. 1 and 2. The system 7 for providing sound includes a substantially unidirectional speaker 1 for directing sound to a target location. The substantially unidirectional speaker 7 directs a sound to the target location in a generally discrete path so that a first person 5 at the target location hears the sound, while a second person 6 proximate to the target location generally does not hear the sound. Unidirectional speakers 1 of this type using ultrasonic or other technologies are known and available in the art. The speakers 1 are selectably positioned to direct sound to the target location, but may be positionally adjustable to allow the target location to be moved. The sound directed to the target location does not mask all other sounds, but instead allows a person 5 inside the target location to hear the sound directed to the target location while still being able to hear other sounds such as the voice of a person outside of the target location, an alarm, a ringing telephone, or an announcement transmitted from a public address system.

An amplifier 2 is operably associated with the unidirectional speaker 1 and with a sound library 4 to transmit sounds from the sound library 4 to the speaker 1. The sound library 4 contains one or more recorded sounds intended to evoke a positive response from a person at the target location. The sounds in the sound library 4 may include sounds recorded in nature such as the sound of a bird, a brook, ocean waves, rainfall, wind, or other sounds found in nature. Also, sounds included in the sound library 4 may be indigenous to the geographic area in which the system 7 is operated, or the geographic area where the listener resides or works. Sounds included in the sound library 4 may also include sounds from one's home, workplace, or other environment. Further, sounds included in the sound library 4 may include music or any other man-made sound that may evoke a positive response from a person 5 at the target location. The sounds included in the sound library 4 may be stored on any of a variety of storage media. For example, the sound library 4 may be stored on a floppy disk, an optical disk, a magnetic tape, a hard drive, a flash memory device, or any other suitable storage medium.

A control system 3 is associated with the amplifier 2 for controlling various aspects of the sound transmitted by the system 7. The control system 3 may allow an operator to select the sound to be directed to the target location from among the sounds included in the sound library 4. Because sounds evoke different responses from different people, the control system 3 allows an operator to choose a sound from the sound library 4 that is more likely to evoke a positive response in the person 5 at the target location. The control system 3 may also allow an operator to adjust the volume of the selected sound to suit the preference of the person 5 at the target location. Further, the control panel 3 may allow an operator to selectively start or stop the sound source or to have the sound source turn off after a period of time of selected or predetermined duration. The control panel 3 may also allow an operator to selectively change the position of a unidirectional speaker to change the direction of the sound directed therefrom. The operator may be the person 5 at a target location or a second person 6 outside of a target location.

Although FIG. 1 shows the control system 3 connected to the amplifier 2, it is easily appreciated that the control system 3 may be connected to the speaker 1, the sound library 4, or any other component of the system 7 to control the operation of the system 7. Further, the control system 3 may be a remote control unit, a panel located in the target location, or integrated with any other component in the system, such as the speaker 1, the amplifier 2, or the sound library 4. The operator may be the person 5 at the target location or a second person 6 located outside of the target location.

The presently claimed subject matter may be utilized in the field of heath care to promote healing. When the claimed subject matter is utilized in this manner, the first person 5 located at a target location is a health care patient. The target location is a location at which the patient will be located for a period of time. For example, the target location may be a hospital bed in which the patient is recovering from a medical procedure. Alternately, the target location may be a station used to draw blood, a station used to measure blood pressure, or a location where the patient is being prepared for or awaiting a medical procedure. In addition, the target location may be a location at which a patient receives chemotherapy, kidney dialysis, or some other treatment during which the patient is immobilized for a period of time.

The health care patient operates the control system 3 to select a sound from the sound library 4. The health care patient may also operate the control system 3 to select other characteristics of the selected sound, such as the volume of the selected sound and the duration for which the selected sound will be played. The amplifier 2 transmits the selected sound to the unidirectional speaker 1. The unidirectional speaker 1 directs the selected sound to the target location at which the health care patient is located. As a result of the unidirectional nature of the speaker 1 directing the selected sound, a second person 6 located proximate to the target location, such as a health care provider or a second health care patient, generally does not hear the selected sound. The health care patient hears the selected sound, and is still able to hear other sounds such as the voice of a caregivers. The selected sound evokes a positive response from the patient, thereby reducing stress in the patient and promoting healing in the patient.

In another embodiment of the present disclosure, the system 7 for providing sound includes a plurality of substantially unidirectional speakers 1, each speaker 1 selectively positioned to direct a selected sound to one of a plurality of target locations. One of a plurality of amplifiers 2 is operably associated with each of the plurality of substantially unidirectional speakers 1 and with one of a plurality of sound libraries 4 to transmit sounds from the sound library 4 to the substantially unidirectional speaker 1. Each of the plurality of sound libraries 4 contains one or more recorded sounds intended to evoke a positive response from a person at a target location. Alternately, the plurality of speakers 1 may be associated with a single, central amplifier 2. Additionally, a single, central sound library 4 may be operably associated with one or more amplifiers 2.

A control system 3 corresponding to each substantially unidirectional speaker 1 is associated with the amplifier 2 for controlling various aspects of the sound emitted from the corresponding speaker 1. A person at the target location of a speaker 1 operates the control system to select and control the sound directed to the target location by the speaker. Further, a centrally located control system 3 may be operably associated with the system 7 to allow a single operator to select and control the sound directed to the target location of each of the plurality of unidirectional speakers 1.

Utilizing the second embodiment of the present disclosure, sounds that evoke a positive response can be selectively directed to a plurality of hospital beds, each bed sited at the target location of a speaker 1. In this manner, a patient in a particular hospital bed can hear the selected sound and a person 6 proximate to the target location will generally not hear the selected sound. Accordingly, when two or more patients are situated in the same room, each patient can listen to a selected sound without disturbing the other patients in the room. Also, the system 7 may be adapted to provide selected sound to a plurality of health care stations located in a particular room or within a particular hospital.

The present sound system is not limited for use in the health care arena, but may be utilized in all situations and locations to provide a selected sound to a target location to evoke a positive response in a person at the target location. For example, the system 7 may be utilized in a home, an office, a workplace, or waiting room. The system 7 may also be utilized in an automobile, a bus, a train, an airplane, or a boat.

While illustrative embodiments have been illustrated and described, it will be appreciated that various changes can be made therein without departing from the spirit and scope of the presently claimed subject matter.

The embodiments of the presently claimed subject matter in which an exclusive property or privelege is claimed are defined as follows:

1. A system for providing sound to a healthcare patient while at a healthcare facility comprising:
(a) a sound library having at least one sound;
(b) a substantially unidirectional speaker selectably positioned to direct a selected sound from the sound library to a target location so that a person at the target location hears the selected sound, and a person proximate to the target location generally does not hear the selected sound;
(c) an amplifier for transmitting the selected sound from the sound library to the substantially unidirectional speaker; and
(d) a control system for controlling at least one of the selection of the selected sound, the volume of the selected sound, and the duration for which the selected sound is directed from the speaker to the target location;
wherein the selected sound from the sound library evokes a positive response from a person at the target location.

2. The system of claim 1 wherein the sound library is stored on at least one of a floppy disk, an optical disk, a magnetic tape, a hard drive, and a flash memory device.

3. The system of claim 1 wherein the control system is operable by a person located at the target location.

4. The system of claim 1 wherein a person located at a target location is at least one of in a bed, having blood drawn, undergoing a blood pressure test, undergoing a chemotherapy treatment, and undergoing kidney dialysis.

5. The system of claim 1 having a plurality of substantially unidirectional speakers wherein each speaker of the plurality of speakers is selectably positioned to direct a selected sound from the sound library to one of a plurality of target locations so that a person located at a target location hears the selected sound and a person located proximate to a target location generally does not hear the selected sound.

6. The system of claim 5 wherein the amplifier transmits a different selected sound from the sound library to each of at least two of the plurality of speakers.

7. The system of claim 6 having a plurality of control systems wherein at least one control system is operable by a person located at at least one target location to control the sound directed to the at least one target location.

8. The system of claim 6 wherein a different sound library is provided for each of at least two of the plurality of speakers.

9. A method for providing a desirable audio environment to a healthcare patient comprising:
(a) providing a sound library having at least one sound to which a patient reacts positively;
(b) unidirectionally directing a selected sound from the sound library so that the patient hears the selected sound and a second person proximate to the patient generally does not hear the selected sound;
(c) amplifying the selected sound from the sound library; and
(d) controlling the volume, duration, and selection of the selected sound.

10. A system for providing directionally specific sound comprising:
(a) at least one sound library having at least one sound;
(b) a plurality of substantially unidirectional speakers, each speaker selectably positioned to direct a selected sound from the at least one sound library to a target location so that a person located at a target location hears the selected sound and a second person located proximate to a target location generally does not hear the selected sound; and
(c) a control system for controlling the selected sound, wherein the control system includes at least one amplifier to transmit the selected sound from the at least one sound library to at least one of the plurality of substantially unidirectional speakers.

11. The system of claim 10 wherein the at least one amplifier transmits a different selected sound to each of two or more of the plurality of speakers.

12. The system of claim 11 wherein a separate sound library is provided for each of at least two of the plurality of speakers.

13. The system of claim 12 wherein the each sound library is stored on at least one of a floppy disk, an optical disk, a magnetic tape, a hard drive, or a flash memory device.

14. The system of claim 10 wherein the control system is operable by a person located at a target location to control the sound directed to the target location by one of the plurality of speakers.

15. The system of claim 10 wherein the system is located in at least one of a home, office, workplace, waiting room, and transportation vehicle.

16. The system of claim 10 wherein the system is located in at least one of an automobile, a bus, a train, an airplane, and a boat.
